(19) United States
(12) Patent Application Publication
(10) Pub. No.: US 2020/0047125 A1
(43) Pub. Date: Feb. 13, 2020

(54) FLUID MANAGEMENT SYSTEM AND METHOD

(71) Applicant: Pani Energy Inc., Vancouver (CA)

(72) Inventors: Devesh BHARADWAJ, Victoria (CA); R. Ian Macdonald, Nanoose Bay (CA); Thomas Fyles, Victoria (CA)

(21) Appl. No.: 16/101,598

(22) Filed: Aug. 13, 2018

(51) Int. Cl. B01D 61/06; B01D 61/08; B01D 61/10; B01D 61/12; B01D 61/02

(52) U.S. Cl. CPC B01D 61/06; B01D 61/08; B01D 61/025; B01D 61/12; B01D 61/10

(57) ABSTRACT

A system for storing fluids provides a plurality of containers, a filtering or osmotic fluid processing system and a fluid crossconnect system for connecting the containers with the processing system. Fluid can be drawn from a selected container, processed and directed back to a container, replacing previously processed fluid. Storage volume required in closed fluid processing systems is thereby minimised.

### FIELD OF THE INVENTION

The invention concerns the storage of fluids, and in particular the management and storage of fluid solutions whereby overall volume requirements are minimised.

### BACKGROUND OF THE INVENTION

Filtering and osmosis systems can be used to filter an original fluid or to separate an original fluid solution into two components for energy storage, or to combine two such components for energy extraction. In some situations both an original fluid and its filtrate or an original solution and its components must be stored. It is desirable to minimise the volume required. One example is the storage of energy by separating an original salt solution into fresh water component and a remnant brine component that is more concentrated than the original solution. Large scale energy storage is possible by this means because the determining factor in capacity is simply the volume of fluid that can be stored. Energy storage can be carried out by any processes that use energy to separate a solution into portions of differing concentration. The recovery of energy can be achieved by any process for recombining the stored portions. Reverse osmosis, electrodialysis and membrane distillation are examples of the former; pressure retarded osmosis, reverse electrodialysis and capacitive mixing of the latter.

A problem for all forms of solution concentration storage is that three different fluids must be stored: a medium- concentration solution that supplies the storage system, and high- and low- concentration component portions of this solution that store the energy and supply the recovery system. Ideally the overall containment system is closed in order to prevent contamination of the fluids. Since the whole volume of the medium- concentration solution may be converted into its high concentration and freshwater portions to be stored, the volume of the medium- concentration tank that supplies the energy storage system and the total volumes of the storage tanks that supply the energy recovery system would have to be the same, requiring an overall volume at least double the volume of the actual fluid used. The total volume would actually be higher unless the storage tank volumes are tailored to the actual concentrations of the separated solutions. Since a major benefit of these systems is that energy storage capacity is set only by the volume required to store fluid, it is a considerable disadvantage if the total storage volume required is significantly more than the volume of fluid actually used. Prior work by Ahmed Aly Fahmy Elsaid as WO2010088919A1 “Osmotic Energy Reservoir” indicates that three containers would be required but offers no comment on the excess volume required or the practicality of this configuration.

In contrast to many other chemical processes in which reagents and their products are stored in tanks, the fluids used for solution concentration energy storage are identical, though at different concentrations. Storage tanks can be reused for any of the fluids with no requirement for cleaning, provided that the tanks can be adequately emptied before refilling. Because contamination of the freshwater by small amounts of solute can rapidly degrade the recoverable power, it may be necessary to flush some tanks and piping before reuse.

During the energy storage phase the volume of medium- concentration fluid is reduced as the aggregate volume of high concentration fluid and freshwater increases; the reverse happens in the energy recovery phase. The overall fluid volume is constant. It is possible in principle to reuse storage space vacated by one type of fluid in order to store another, thus more closely approaching a total storage volume equal to the total volume of fluid actually used. A previous system for water storage in limited space used a single storage volume for multiple solutions with internal bladders to separate the liquids (Evans, R. E. GB2111939A, 1981, “Compartmented containers”), however such a system is unsuited for the large volumes that would be needed for energy storage.

Another situation in which components may be separated from a fluid and in which storage volume is important is in the large-scale shipboard filtration of water. A large volume of untreated freshwater may be taken onboard a tanker in one location for delivery elsewhere as treated freshwater. It may be convenient to treat the water by filtration during transport, but this is possible only if filtration can be done with minimal impact on the payload volume that can be carried.

We describe a method and apparatus for the closed storage of fluids in a multiplicity of tanks which are be re-used so that various fluids may be stored in any of the tanks. By this means energy storage, energy recovery or filtration can be carried out with a minimum requirement for storage volume.

### BRIEF DESCRIPTION OF DRAWINGS

FIG. 1 shows a method of storing an original fluid and two components derived from that fluid in an array of tanks.

FIG. 2 shows a method of storing two components of a fluid and their combination in an array of tanks.

FIG. 3 shows a method of storing an original fluid and a filtrate derived from it in an array of tanks

FIG. 4 shows a fluid storage system according to the invention wherein a fluid crossconnect directs a solution from a storage container to an osmotic energy storage system and directs the outputs of the osmotic energy storage system to previously emptied storage containers.

FIG. 5 shows a fluid system according to the invention wherein a fluid crossconnect directs solutions from storage containers to an osmotic energy recovery system and directs the output of the osmotic recovery storage system to previously emptied storage containers.

FIG. 6 shows a general form of fluid crossconnect in possible connections between a group of tanks and a group of osmotic systems are provided by a matrix of routing valves.

FIG. 7 shows a fluid crossconnect composed of a sparse matrix of routing valves, in which inputs and outputs of the crossconnect are grouped separately. The figure shows how pump connections can be provided at the crossconnect inputs and outputs so that other inputs and outputs can be connected via a pump.

FIGS. 8a and b show the operation of a six-port valve configured as a routing valve for a fluid crossconnect

FIG. 9 shows a routing valve composed of on-off valves and Y-branches

FIG. 10 shows a fluid crossconnect composed of multiport selector valves.

### DESCRIPTION OF THE DRAWINGS

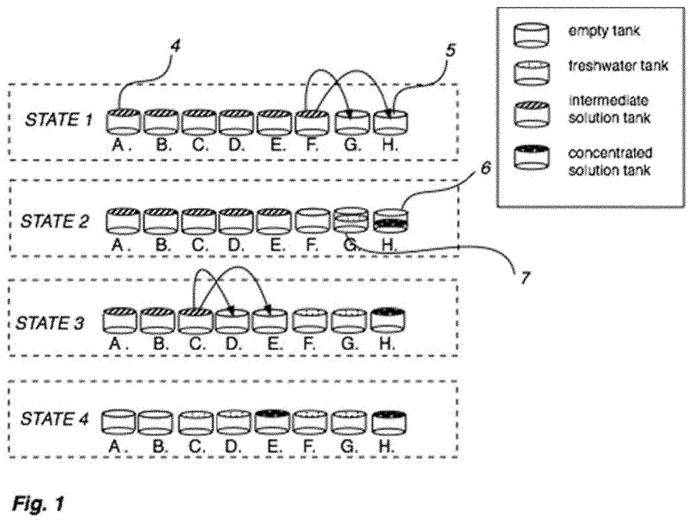

An illustration of the inventive method of tank re-use is shown in FIG. 1 in connection with an energy storage system. Eight tanks of equal volume are shown, labelled A through H. Before energy storage begins, six tanks, A through F, are full of intermediate concentration solution, and two tanks, G and H, are empty. An energy storage system, not shown, separates the intermediate concentration solution into freshwater and a high concentration solution in volume ratio Y/(1−Y). For the example in the diagram Y=1/3. Both solutions are to be stored.

In initial State 1 intermediate solution is taken into the energy storage system from tank F, high concentration solution output from the energy storage system is directed to tank H and freshwater to tank G.

In State 2 tank F has been emptied, tank H is one-third full of high concentration solution and tank G is two thirds full of freshwater. The source of intermediate solution for the energy storage system is switched to tank E and tank F is now available for storage. It will be used for freshwater when tank G is full.

In State 3 tanks D, E, and F, initially full of intermediate solution, have been emptied. High concentration solution entirely fills tank H. Freshwater fills two tanks: tank G where it was initially stored, and tank F where it was stored after State 2. Intermediate concentration fluid is sourced from tank C, high concentration fluid is directed to tank E and freshwater to tank D. The situation recapitulates State 1.

In State 4 the process has been repeated with the remaining tanks. Tanks E and H are entirely full of high concentration fluid, tanks C and D are full of freshwater, and tanks A and B are empty. Thus the six tanks of intermediate concentration solution have been processed into high and low concentration solutions and stored, with a storage requirement of only eight tanks.

When all the intermediate fluid has been converted into storage solutions the number of tanks holding each solution will depend on the ratio of the volumes of the fluids produced. The ratio may not map to an integral number of tanks for each solution, but any tank that is only partially full has to be considered to be in use and required. It can be shown that if N tanks of equal size are used to store an intermediate concentration solution, N+2 tanks suffice to store high and low concentration portions extracted from it irrespective of of the value of Y.

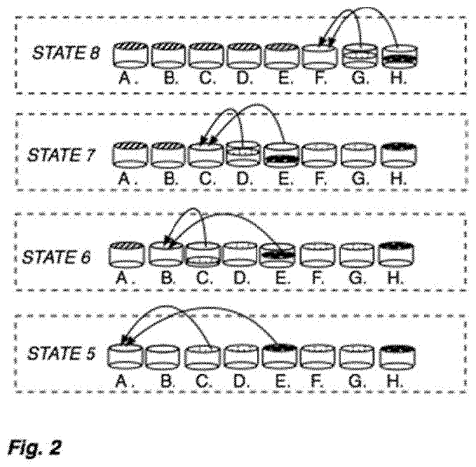

FIG. 2 shows the reverse operation for recovering energy stored in the form of solution concentration difference. In this example too, Y=1/3. In State 5 high concentration solution from tank E is combined with freshwater from tank C to generate energy and the resulting intermediate concentration solution is stored in tank A until it is full, and then, in State 6 it is stored in tank B. In state 7 the freshwater in tank C has been exhausted so the source of freshwater is changed to tank D and tank C is used to store intermediate fluid. Finally in state 8 the remaining freshwater in tank G and high concentration solution in tank H are combined into tank F.

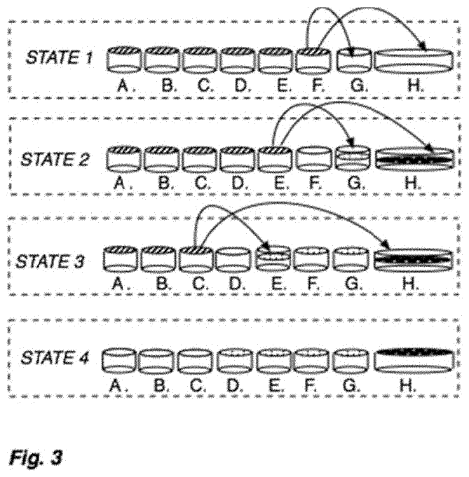

Although tanks of equal volume have been described it will be understood that storage tanks of differing volumes may be used. For example, it is desirable that the concentration difference between the two stored solutions be as high as possible, which implies a large volume of freshwater compared to the volume of concentrated solution. For this reason it may be advantageous to have a relatively small dedicated storage volume for the concentrated solution. Such an energy storage situation is shown in FIG. 3, where tank H is used only for concentrated brine, and tanks A-G that initially contained intermediate fluid are reused only for freshwater storage. In a filtering situation one component of the initial fluid might not be retained at all, and tank H would represent a waste container in that case.

The flow of the various solutions must be managed actively during energy storage or energy recovery to ensure that the correct fluids are directed to the correct tanks, requiring a method of routing the solutions between the tanks and the energy storage and energy recovery systems. An aspect of the current invention provides such a management system and method.

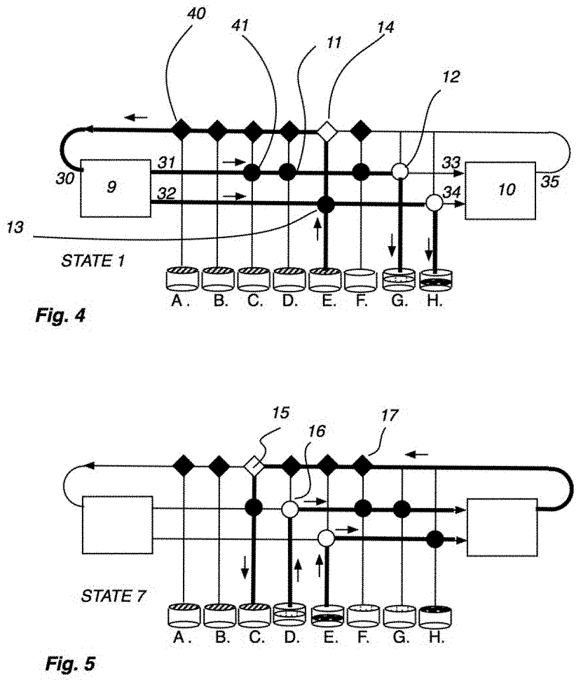

An example of a fluid management system according to the invention is shown in FIGS. 4 and 5 in connection with the storage and generation of energy. A solution separation system 9 that takes in intermediate concentration solution at port 30 and by expenditure of energy produces high concentration solution at output port 31 and low concentration solution at output port 32, a solution combination system 10 that takes in high concentration solution at port 33 and low concentration solution at port 34, yields energy and produces intermediate concentration solution at port 35, and storage tanks A-H are interconnected via an array of routing valves 40, 41 and pipe routes that allow various solutions to be stored in or supplied from tanks as appropriate. FIG. 4 shows valve settings corresponding to energy storage State 1 of FIG. 2 by indicating with a solid symbol a valve setting in which solutions pass straight through the valve in the horizontal or vertical direction, and with an outline symbol a valve setting in which solutions are diverted from a horizontal manifold into a tank, or taken from a tank and redirected into a horizontal manifold. FIG. 5 shows the same system with valve settings appropriate to energy recovery State 7 shown in FIG. 3. While both solution separation system 9 and solution combination system 10 are shown as simultaneously present so that the overall system is capable of both storing and recovering energy, it is recognised that either solution separation system 9 or the solution combination system 10 may be absent, so that only an energy generation or an energy storage system results.

FIGS. 4 and 5 are illustrative. It will be understood that various configurations of valves and pipes are possible to achieve the selectable delivery of solutions to and from an array of storage tanks. In particular, the figures show bidirectional pipes from the valves to the tanks. In some implementations it may be advantageous to use separate pipes to deliver solutions to the tanks and to extract solutions from the tanks, with separate valves to connect these pipes to the manifolds. By analogy with telecommunication switching, a system that can provide selectable delivery of solutions to and from an array of storage tanks and the ports of osmotic energy storage and recovery systems, is here termed a “fluid crossconnect”.

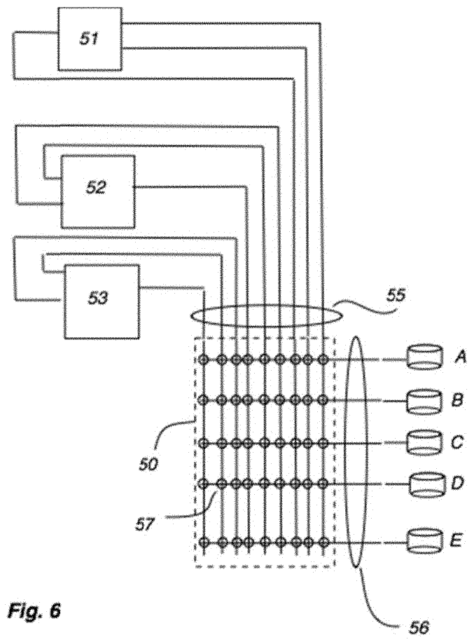

In FIG. 6 a fluid crossconnect 50 is shown in a general form. A first group of ports 55 is connected to one or more osmotic or filtration systems 51, 52, 53. A second group of ports 56 is connected to a plurality of storage containers or tanks A-E. Within the fluid crossconnect 50 the fluid paths from the ports of the two groups 55, 56 cross over each other, forming a matrix. Routing valves 57 located at the crossovers selectably provide either simultaneous, noncommunicating crossing paths, or a connection between the paths that cross.

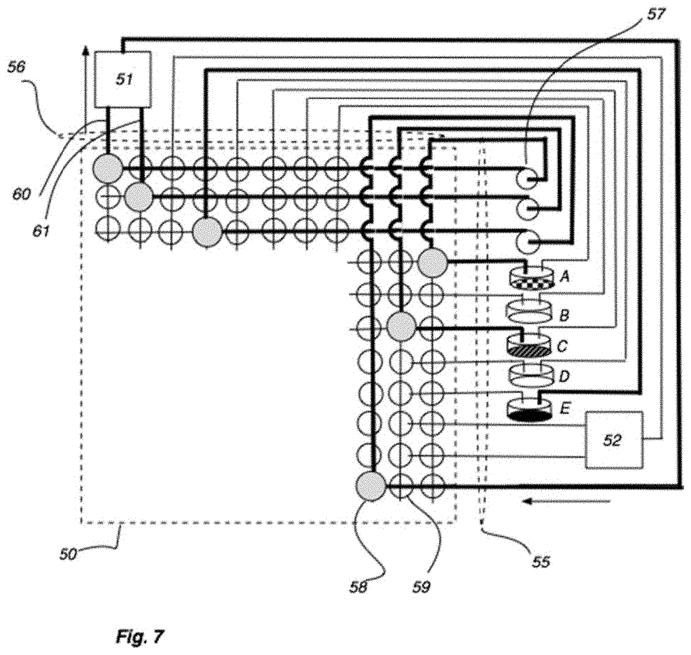

Various configurations of routing valves and pipes are possible to achieve the function of a fluid crossconnect. In addition to filtering or osmotic systems, devices such as pumps or checkvalves may also be connected through a fluid crossconnect. While fluid connections established through a fluid crossconnect may be used in either direction, it is convenient to consider one set of crossconnect ports to be inputs, and the other to be outputs. FIG. 7 shows a fluid crossconnect in which one set of ports 55 serves for input, and the other 56 for output. The crossconnect also includes pumps 57 that can be switched into a a path between input and output. By means of heavy lines the figure shows the connection of tanks A,C to the inputs 60, 61 respectively of PRO system 51, with each connection first leading through one of the pumps 57. In the diagram those routing valves that do not form a cross connection are shown as open circles, 59, whereas routing valves set to connect an input port to an output port are shown as filled circles, 58. The full set of routing valves of the fluid crossconnect 50 is not required in this particular design because it provides only for routes through pumps. Connections directly between other elements could be provided by populating other crossings of the matrix with routing valves. Any possible connection pattern could be set up by operating the routing valves.

Routing valves within a fluid crossconnect are fluid routing systems that can selectably provide paths, in some cases more than one at a time. In the system shown in FIGS. 4 and 5 two types of routing valves can be identified depending on whether both a horizontal and a vertical through-path are required (41) or only a horizontal one (40). Settings of the valves connect a manifold to deliver solution to or from a tank (11,12,14,15) or pass the manifold contents onward (11,17) to deliver solution to the recovery unit 10 or the storage unit 9 or to reach another manifold (13). The routing requirement is simplified when inputs and outputs are grouped, as in crossconnect 50. It is only necessary to provide a crossing function from input ports to output ports and a through-connection.

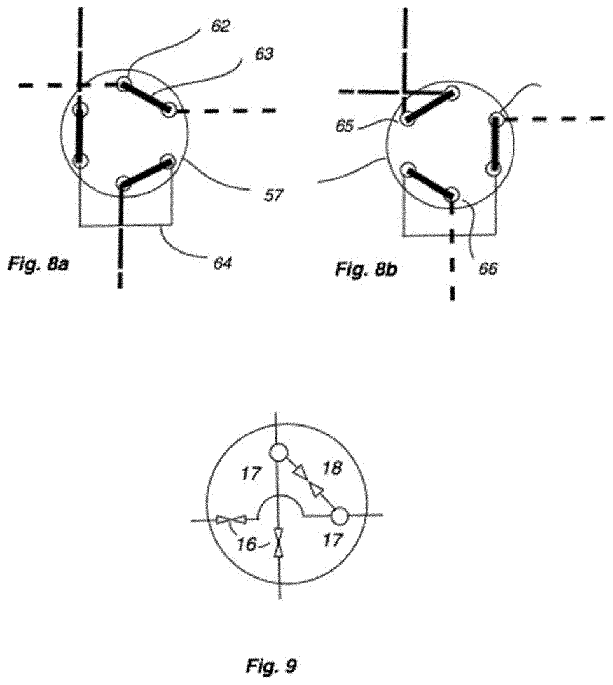

Routing valves can be implemented in various ways. A single device that can be configured to perform all the routing valve functions in crossconnect 50 is a six-port valve, as shown In FIG. 8a and b. The valve has six ports 62 that are connected in pairs by internal connections 63. The internal connections can be configured in two different states connecting the ports in two different sets of pairs as shown in FIGS. 7a and b. An external permanent connection 64 is made between two of the ports as shown, with the result that in FIG. 8a fluids pass through the valve independently in the vertical and horizontal direction, while in FIG. 8b fluid paths between the top port 62 and the left port 65, and independently between the bottom port 66 and the right 67.

Other implementations are possible, including implementations using only shutoff valve elements and passive branching elements as shown in FIG. 9. If valves 16 and 17 are closed and valve 18 is open the fluid passes the two branches 17 via the route between the top port and the right port. If valve 16 and 17 are open and 18 is closed the fluids pass independently through in the horizontal and vertical direction.

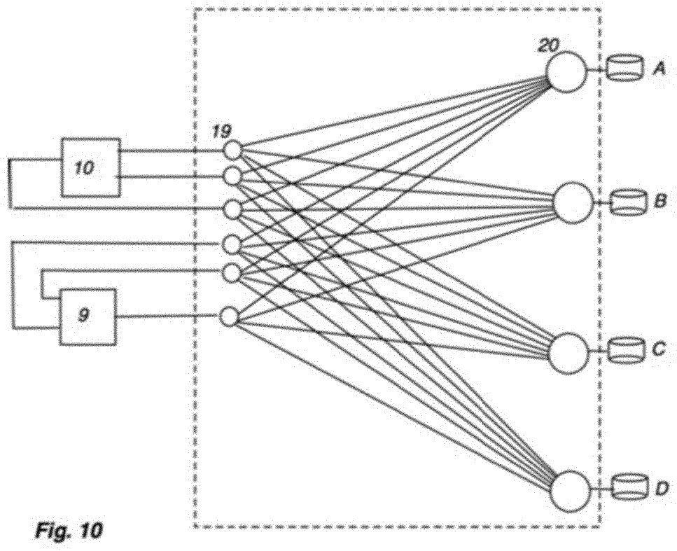

In FIG. 10 another embodiment of a fluid crossconnect is shown in which connections are selected using one-to-many or many-to-one selector valves 19, 20. A connection is established by setting the selector valves at each end of a desired connection.

A tank array and fluid crossconnect can be used to provide flexibility to solution concentration storage systems. For example multiple storage systems or recovery systems can be included and selectively connected to a single set of tanks. By this means the outputs of two RO systems can be individually connected to an array of storage tanks so that a high concentration fluid used in recovery is produced by one RO system, and a low concentration fluid by the other. This may be done for redundancy. Further, if two RO systems are operated to produce differing concentrations, a PRO system can be operated with concentrations and volumes that do not match, leading to an excess of one fluid when energy is recovered. Such flexibility may be useful if a storage system works in parallel with a desalination system. A fluid crossconnect can provide the ability to transfer fluid from one tank to another for flushing purposes.

A tank array and fluid crossconnect system of the types discussed above will require programmed control of fluid flows, valves, and tank allocations to operate efficiently. These controls will be required to ensure that fluid flows to and from the filtering and osmosis systems fall within the design requirements of those systems, and within the volume and fluid composition states of the tanks. Such control systems will require inputs from sensors throughout the tank array and fluid cross connect system. These sensors may include sensors for fluid flow, fluid pressure, fluid temperature, current tank volume, and fluid composition parameters.

In a fully implemented fluid crossconnect the number of valves required at pipe intersections is proportional to the product of the number of tanks and the number of pipes leading to RO and PRO systems, and therefore rises rapidly as these numbers increase. If very large numbers of tanks must be interconnected with very large numbers of RO and PRO systems, a saving in the number of valves can be obtained by a multistage crosspoint architecture such as that described by Charles Clos “A Study of Non-blocking Switching Networks,” Bell Syst. Tech. J., vol. 32, 3/53, pp. 406-424, published in 1953.

1. A system for storing fluids comprising:
a plurality of containers for containing an original fluid, or a filtrate or separated component of the original fluid, or a remnant component of the original fluid;
a filter for filtering the original fluid or an osmotic system for osmotically separating the original fluid into a separated component of the original fluid and a remnant component, or for recombining the separated component and the remnant component;
a fluid crossconnect system having two groups of ports, for selectably providing fluid communication between ports of one group and ports of the other group, wherein some of the ports are connected to the containers or to the filter or osmotic system such that fluid can be drawn from a selected container and directed to the filter or osmotic system and simultaneously the output of the filter or osmotic processor can be directed to one or more selected containers.

2. A system for storing fluids as defined in claim 1 wherein the fluid crossconnect system comprises a matrix of routing valves or valve assemblies for routing a fluid between ports.

3. A system for storing fluids as defined in claim 2 including a control system for operating the matrix of routing valves.

4. A system for storing fluids as defined in claim 1, wherein the fluid crossconnect system has input port selector valves for selectably directing a flow from an input port to an output port, and output port selector valves for selectably receiving a flow from an input port.

5. A system for storing fluids as defined in claim 4 including a control system for operating the selector valves.

6. A system for storing fluids as in claim 1, wherein at least one port of the crossconnect is connected to a pump.

7. A method of storing fluids including:
storing an original fluid in a plurality of containers;
using a fluid crossconnect to direct the original fluid from a container to a filtering system for producing a filtered fluid;
using the fluid crossconnect to direct flushing fluid to a container previously having contained the original fluid;
using a fluid crossconnect to direct the filtered fluid into the flushed container.

8. A method of storing fluids including:
storing an intermediate concentration solution in a plurality of containers;
using a fluid crossconnect to direct the intermediate concentration solution from a container to a system for separating a solution into a more- concentrated solution and a more- dilute solution;
using a fluid crossconnect to direct the more- concentrated solution and the more- dilute solution into separate empty containers, at least one container previously having contained the intermediate concentration solution.

9. A method of storing fluids including:
storing a high concentration solution and a lower concentration solution separately in a plurality of containers;
using a fluid crossconnect to direct a high concentration solution and a lower concentration solution separately from a container to a system for combining solutions and extracting energy therefrom;
using a fluid crossconnect to direct an intermediate concentration solution produced by a system for extracting energy, to a container previously having contained either a high concentration solution or a low concentration solution previously directed to a system for extracting energy.

10. A method of storing fluids as in claim 8 including directing freshwater to a container to flush out a remnant of its previous contents.

11. A method of storing fluids as in claim 9 including directing freshwater to a container to flush out a remnant of its previous contents.
